(19) United States
(12) Patent Application Publication
(10) Pub. No.: US 2016/0077234 A1
(43) Pub. Date: Mar. 17, 2016

(54) Compensated Sigma Calculation Based On Pulsed Neutron Capture Tool Measurements

(71) Applicant: SCHLUMBERGER TECHNOLOGY CORPORATION, Sugar Land, TX (US)

(72) Inventors: Tong Zhou, Sugar Land, TX (US); Sicco Beekman, Houston, TX (US); Scott H. Fricke, Houston, TX (US)

(21) Appl. No.: 14/787,352

(22) PCT Filed: Apr. 30, 2014
(86) PCT No.: PCT/US2014/036095

§ 371 Date: Oct. 27, 2015

Related U.S. Application Data
(60) Provisional application No. 61/817,714, filed on Apr. 30, 2013.

(51) Int. Cl. G01V 5/10

(52) U.S. Cl. CPC G01V 5/102

(57) ABSTRACT

A method for determining thermal neutron decay constant for a formation includes counting radiation events corresponding to numbers of thermal neutrons with respect to time (decay spectrum) after irradiating the formation with neutrons. At least one moment of a first order of the decay spectrum or a single exponential curve to fit the decay spectrum is determined. A first apparent decay constant from the at least one moment or the single exponential curve. A second apparent decay constant is determined either by repeating the calculating a moment or exponential curve for different time segments of the decay spectrum or by using radiation events detected by at least a second radiation detector at a different spacing from a position of the irradiating than the at least a first radiation detector to determine a second apparent decay constant. A wellbore corrected thermal neutron decay constant is determined from the first and second apparent decay constants.

### CROSS-REFERENCE TO RELATED APPLICATIONS

This application claims priority to and the benefit of U.S. Provisional Application Ser. No. 61/817,714 entitled “Compensated Sigma Calculation Based On Pulsed Neutron Capture Tool Measurements”, filed Apr. 30, 2013, the disclosure of which is hereby incorporated by reference in its entirety.

### BACKGROUND

This disclosure relates generally to the field of pulsed neutron well logging for determining macroscopic thermal neutron capture cross section (sigma) and/or its converse thermal neutron decay time constant. More specifically, the invention relates to techniques for making such determinations which account for wellbore effect of neutron diffusion.

Formation sigma determination based on measurements of capture gamma rays resulting from a pulsed neutron source has been used in the petroleum industry for several decades. It is essentially a thermal neutron “die-away” measurement, which responds to the macroscopic thermal capture cross section of the formation. The decay of the thermal neutron population is close to exponential in an ideal situation (for example, a homogeneous uniform condition), while the actual shape of the decay curve with respect to time may not be representable by an analytic formula. An apparent decay constant (based on either a fitting or moments method) is not always equal or close to the actual formation decay constant. Wellbore decay contamination and thermal neutron diffusion affect the apparent decay constant. In some conditions (for example, high salinity water in the wellbore and a formation sigma that is much smaller than the corresponding borehole sigma), at least two decay constants can be observed, and the decay of the thermal neutron population is very close to a dual exponential decay. However, such dual exponential decay is not always evident. Obtaining accurate and precise formation sigma measurements under all formation and wellbore conditions is very challenging.

### SUMMARY

A method according to one aspect for determining thermal neutron decay constant for a formation includes counting radiation events corresponding to numbers of thermal neutrons with respect to time (decay spectrum) after irradiating the formation with neutrons. At least one moment of a first order of the decay spectrum or a single exponential curve to fit the decay spectrum is determined. A first apparent decay constant from the at least one moment or the single exponential curve. A second apparent decay constant is determined either by repeating the calculating a moment or exponential curve for different time segments of the decay spectrum or by using radiation events detected by at least a second radiation detector at a different spacing from a position of the irradiating than the at least a first radiation detector to determine a second apparent decay constant. A wellbore corrected thermal neutron decay constant is determined from the first and second apparent decay constants.

Other aspects and advantages will be apparent from the description and claims that follow.

### BRIEF DESCRIPTION OF THE DRAWINGS

FIG. 1 shows an example logging instrument that may be used in some examples.

FIG. 1A shows an example well logging instrument being moved along the interior of a wellbore.

FIG. 2 shows an example of the neutron pulsing scheme and the associated detected time spectrum.

FIGS. 3A and 3B show early and late apparent sigma computed, respectively, using the first order moment method.

FIGS. 4A and 4B show early and late sigma compensation and their accuracy.

FIG. 5 shows the late fraction is a linear function of the difference between early and late first-order moment sigma.

FIGS. 6A and 6B show late fraction sigma compensation and their accuracy.

FIGS. 7A and 7B show, respectively, apparent sigma computed using first order moment and second order moment method.

FIGS. 8A and 8B show, respectively, high-order moment sigma compensation and its accuracy.

FIGS. 9A and 9B show, respectively, early and late apparent sigma computed using the zero order moment method.

FIGS. 10A and 10B show, respectively, zero-order moment sigma compensation and its accuracy.

FIGS. 11A and 11B show, respectively, near detector and far detector apparent sigma computed using the first order moment method.

FIGS. 12A and 12B show, respectively, multiple-detector sigma compensation and its accuracy.

FIG. 13 shows an example computer system.

### DETAILED DESCRIPTION

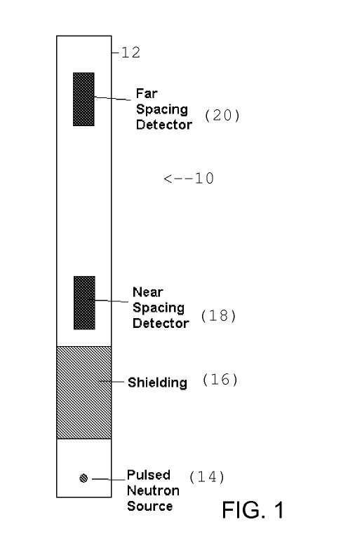

FIG. 1 shows an example pulsed neutron well logging instrument 10. The measurement components of the instrument 10 may be disposed in a housing 12 shaped and sealed to be moved along the interior of a wellbore. The pulsed neutron well logging instrument 10 may, in a form hereof, be of a type described, for example, in U.S. Pat. No. 5,699,246.

The instrument housing 12 contains a pulsed neutron source 14, and two or more gamma ray detectors 18, 20 at different axial spacings from the pulsed neutron source. The pulsed neutron source 14 (hereinafter “source”), when activated, will emit controlled duration “bursts” of high energy neutrons (approximately 14 MeV, and which may be emitted isotropically). One example of a pulsed neutron source is described in U.S. Pat. No. 5,293,410 issued to Chen et al. and incorporated herein by reference.

Shielding 16 may be interposed between the source 14 and the axially closest detector (e.g., 16) to reduce the effects of direct neutron communication between the source 14 and the detectors 18, 20. The detectors 18, 20 may be scintillation counters each coupled to a respective counter or pulse height analyzer (not shown separately). Thus, numbers of and, with the use of a pulse height analyzer, energy of detected gamma rays may be characterized at each of a plurality of distances from the source 14.

The gamma ray detectors 18, 20 may detect gamma rays arriving at the detector as a function of time. There are two principal mechanisms, through which a neutron-induced gamma ray can be generated. One is neutron inelastic scattering, which can be triggered only by “fast” neutrons (with energy above approximately 1 MeV, the exact energy threshold depending on the type of nucleus). The other is through neutron capture, which can be triggered primarily by thermal neutrons (with energy around 0.025 eV at room temperature) or epithermal neutrons (with energy from about 0.4 to 100 eV) being absorbed into a susceptible nucleus, as non-limiting examples, chlorine, boron and cadmium. Gamma rays arriving at the detectors 18, 20 may be generated through both mechanisms because the source keeps emitting fast neutrons which can slow down to epithermal or thermal almost instantly (relative to the acquisition system timing. For purposes of the present disclosure, gamma rays corresponding to capture of thermal neutrons by susceptible nuclei are those of interest.

The detectors 18, 20 may also be any type of thermal neutron detector, e.g., ³He proportional counters. Gamma ray detectors may be preferable because of their higher sensitivity, and resulting higher count rates and associated statistical precision.

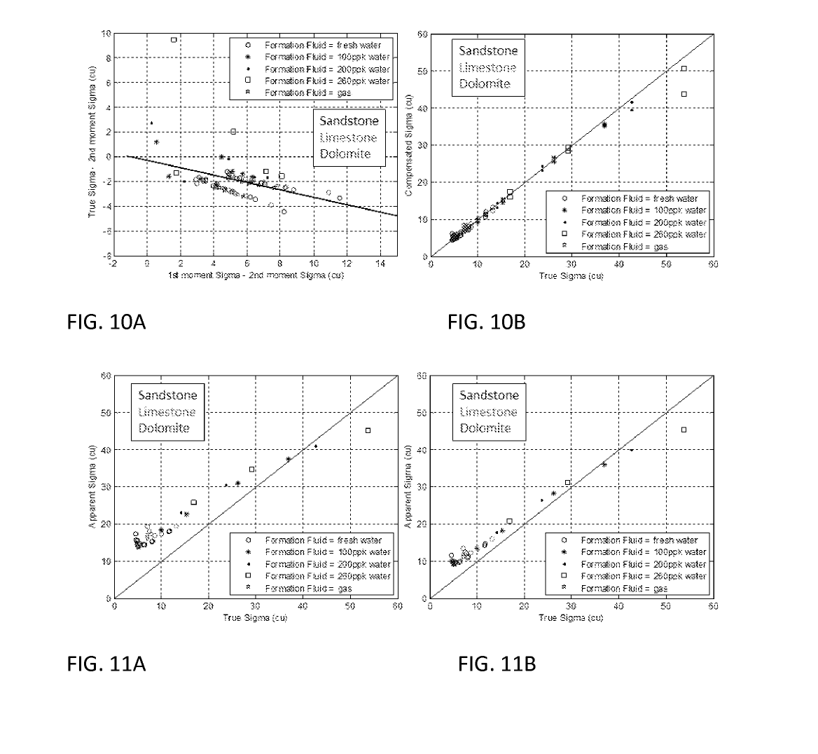

A well logging instrument including a scintillation detector type radiation counter is shown at 210 in FIG. 1A as it is ordinarily used in a procedure to make measurements of properties of subsurface Earth formations penetrated by a wellbore. The wellbore 212 is drilled through the formations, shown generally at 215. The wellbore 212 may be filled with liquid called “drilling mud” 214 during the drilling and well logging procedure, or some form of brine or other completion fluid after wellbore construction is completed. The well logging procedure includes lowering the well logging instrument 210 into the wellbore 212. The instrument 210 may be attached to one end of an armored electrical cable 216. The cable 216 is extended into the wellbore 212 by a winch 218 or similar spooling device to lower the instrument 210 into the wellbore 212. The winch 218 may then be operated to withdraw the cable 216 from the wellbore while various sensors (to be further explained) in the instrument 210 make measurements of various properties of the formations 215 penetrated by the wellbore 212. Electrical power may be transmitted along the cable 216 from the surface to operate the instrument 210. Signals corresponding to the measurements made by the various sensors in the instrument 210 (e.g., explained above with reference to FIG. 1) may be transmitted along the cable 216 for recording and/or interpretation in a recording unit 220 at the Earth's surface, or in a computer system as will be explained with reference to FIG. 10.

The present example of the well logging instrument may be an instrument that makes measurements corresponding to selected properties of the Earth formations 215 based on analysis of detected capture gamma rays, or detected thermal neutrons, with respect to time after each operation of the pulsed neutron source (14 in FIG. 1). Such instruments include a housing 210A in which is disposed certain electronic circuitry, shown generally at E and to be further explained below. The housing 210A may or may not include a backup pad or arm 210B that is biased to one side of the instrument 210 to urge the other side of the instrument 210 into contact with the wall of the wellbore 212. The other side of the instrument 210 may or may not include a tungsten or similar high density skid or pad 210C in which is disposed a source radiation RS, which may be a pulsed neutron source as explained with reference to FIG. 1 above. Although the example instrument shown in FIG. 1A includes various components disposed in a skid or pad, in other examples, the components may be disposed entirely within the instrument housing as shown in FIG. 1.

One or more radiation detectors (e.g., 18 and 20 as explained with reference to FIG. 1) including a scintillation detector crystal XTAL optically coupled to a photomultiplier PMT may be disposed in the pad 210C. A controllable high voltage power supply HV is coupled to the photomultiplier PMT to enable photons applied thereto to be converted to voltage pulses as will be familiar to those skilled in the art. The voltage output of the high voltage power supply HV can be controlled by a controller (not shown separately in FIG. 1A) forming part of the circuitry E to cause the high voltage supply HV maintain a suitable voltage on the photomultiplier PMT. The example instrument shown in FIG. 1A is intended to illustrate an example of conveyance of an instrument in a wellbore as well as to explain examples of detector types that may be used in accordance with the present disclosure in order to obtain measurements that may be processed as will be further explained below.

While the example conveyance of a well logging instrument as shown in FIG. 1A uses armored electrical cable, the foregoing is not intended to limit the scope of instrument conveyance according to the disclosure. Any known means of conveyance may be used in other examples, including, without limitation, as part of a drill string as a logging while drilling (LWD) instrument, conveyed by coiled tubing or slickline.

The present disclosure explains use of the moment method to compute the apparent decay constant. There are some varieties of the moment methods, which are described in more detail below. “Moment” as used herein may be broadly defined as the shape of a set of data points. All the described methods are based on the assumption that the thermal neutron decay curve is a single exponential decay, and the decay constant thus determined corresponds to the thermal neutron capture cross section of the formation adjacent to the logging instrument. In reality, this assumption is generally incorrect because there are borehole contamination and diffusion effects in addition to formation decay in the counting rate of the detected thermal neutrons or capture gamma rays. Thus correction may be performed after computing the apparent sigma from

In addition to moment methods, one can also compute the apparent decay constant by using a single exponential fit. The results of the single exponential fit are very similar to the ones of the first order moment method.

Instruments such as shown in FIGS. 1 and 1A, or the surface logging unit may include circuitry to count numbers of gamma rays or thermal neutrons (hereinafter thermal neutron radiation events, or for convenience “radiation events”) detected in discrete-length time windows (“bins”). Each bin may be only a few microseconds in length, and the bins may be contiguous so that in effect a continuous detection count rate may be recorded over a selected duration time window or time “gate.”

FIG. 2 shows a graph representing an operating cycle of a pulsed neutron instrument such as shown in FIG. 1. At time=zero, the pulsed neutron generator is turned on for a selected duration (“burst time”). At the end of the neutron burst, measurements of capture gamma rays or thermal neutrons (radiation events) may begin. The numbers of detected thermal neutrons or capture gamma rays (radiation events) is represented by curve 40 in FIG. 2. At a certain time, the numbers of detected thermal neutrons or detected gamma rays (radiation events) represent only background radiation and/or neutron activation radiation and the cycle ends, e.g., at 1200 microseconds after initiation of the burst in the example shown in FIG. 2. The end of the neutron burst may be defined as t₀ (time=0) for purposes of the following explanation. The curve shown at 40 in FIG. 2 may be referred to for convenience hereinafter as the “decay time spectrum.”

Equation 1 shows how to compute an apparent thermal neutron decay constant using the first order moment from a measured thermal neutron decay time spectrum, where fᵢ is the count rate in the i-th time bin and tᵢ is the time of the i-th time bin with respect to the end of the neutron bust generated by the pulsed neutron source (14 in FIG. 1).

$${τ}^{′} = \frac{{\sum }_{i = 0}^{I} ( {t}_{i} - {t}_{0} ) \cdot {f}_{i}}{{\sum }_{i = 0}^{I} {f}_{i}} \qquad ( 1 )$$

Assuming the decay time spectrum is a single exponential decay, Equation 2 shows the theoretical first order moment method, which is the first order moment divided by the zero order moment.

$$\frac{{\int }_{0}^{∞} t \cdot {e}^{- \frac{t}{x}} \cdot d t}{{\int }_{0}^{∞} {e}^{- \frac{t}{x}} \cdot d t} = \frac{- t \cdot x \cdot {e}^{- \frac{t}{x}} {{\vert}_{0}^{∞} + {x}^{2} \cdot {e}^{- \frac{t}{x}} \vert}_{0}^{∞}}{x \cdot {e}^{- \frac{t}{x}} {\vert}_{0}^{∞}} = \frac{{x}^{2}}{x} = x \qquad ( 2 )$$

If it were possible to integrate Equation 2 from t=0 to infinite time, the result of Equation 2 provides the decay constant x of the single exponential decay. Since in reality one cannot measure the decay time spectrum to infinity, the integration can only be performed from time=0 to a certain time T. This is shown in Equation 3.

$${x}^{′} = \frac{{\int }_{0}^{T} t \cdot {e}^{- \frac{t}{x}} \cdot d t}{{\int }_{0}^{T} {e}^{- \frac{t}{x}} \cdot d t} = \frac{- t \cdot x \cdot {e}^{- \frac{t}{x}} {{\vert}_{0}^{T} + {x}^{2} \cdot {e}^{- \frac{t}{x}} \vert}_{0}^{T}}{x \cdot {e}^{- \frac{t}{x}} {\vert}_{0}^{T}} = \frac{{x}^{2} \cdot ( 1 - {e}^{- \frac{T}{x}} - \frac{T}{x} {e}^{- \frac{T}{x}} )}{x \cdot ( 1 - {e}^{- \frac{T}{x}} )} = x \cdot ( 1 - \frac{\frac{T}{x} {e}^{- \frac{T}{x}}}{1 - {e}^{- \frac{T}{x}}} ) \qquad ( 3 )$$

Equation 4 shows the result of the finite integration of Equation 3 is x′.

$$Finite\_corr ≡ \frac{{x}^{′}}{x} = ( 1 - \frac{\frac{T}{x} {e}^{- \frac{T}{x}}}{1 - {e}^{- \frac{T}{x}}} ) \approx 1 - 8 \cdot {( \frac{T}{{x}^{′}} )}^{3} \qquad ( 4 )$$

Equation 5 shows an approximation for the decay constant expressed in terms of x′ and the finite correction.

$$x = \frac{{x}^{′}}{Finite\_corr} \approx \frac{{x}^{′}}{1 - 8 \cdot {( \frac{T}{{x}^{′}} )}^{3}} \qquad ( 5 )$$

When T goes to infinity, x′ converges to x. In order to obtain x from x′, a correction is needed for the finite integral effect. The correction term is defined in Equation 6, which is a function of T/x. t₁ represents the ending time of the measurement gate, which as will be further explained below, may be selected or optimized for particular purposes.

$$τ \approx \frac{{τ}^{′}}{1 - 8 \cdot {( \frac{T}{{τ}^{′}} )}^{3}} , where T = {t}_{I} - {t}_{0} \qquad ( 6 )$$

Since x is unknown, one may estimate the correction term using x′. This cannot be performed analytically, but may be performed empirically. One can generate a good approximation of the exact correction term for a wide, realistic range of T/x, and try to reproduce the correction term using T/x′ based on an empirical equation, lookup table or similar means when processing data from the logging instrument. The formula in Equation 6 shows an example of such an empirical equation. One may different equations or may estimate the correction term iteratively. Then, one may estimate the decay constant x using the approximated correction term and x′ from the moments as shown in Equation 6. Similarly, for a measured discrete neutron decay time spectrum, one can apply the same correction term to τ′ in Equation 1 to obtain the apparent decay constant, as shown in Equation 6. At the end, one may compute the apparent sigma from the apparent decay constant T using Equation 7.

$$Σ = \frac{4545}{τ} \qquad ( 7 )$$

The apparent sigma thus computed is related to the starting time (t₀) and end time (T) of the measurement time gate (wherein the gate ending time is represented by t₁ as explained above). Varying the starting time will not only change the borehole and diffusion effect in the apparent decay constant, but will also change the statistical precision. An apparent sigma based on an early gate starting time will have more borehole and diffusion effect than one with a later starting time, because borehole decay and diffusion typically occur early after the end of the neutron burst, and formation decay often happens later. Varying the end time of the measurement gate will only change the statistical precision due to the presence of activation background radiation, which needs to be subtracted from the measurements before determining the decay constant.

The second order moment method is similar to the first order moment method. Instead of computing a first order moment divided by a zero order moment, this method computes a second order moment divided by a first order moment, as shown in Equation 8.

$${τ}^{′} = \frac{1}{2} \cdot \frac{{\sum }_{i = 0}^{I} {( {t}_{i} - {t}_{0} )}^{2} \cdot {f}_{i}}{{\sum }_{i = 0}^{I} ( {t}_{i} - {t}_{0} ) \cdot {f}_{i}} \qquad ( 8 )$$

Equation 9 shows if the decay time spectrum is a single exponential, the second order moment method will compute the decay constant x by integrate from 0 to infinity.

$$\frac{1}{2} \cdot \frac{{\int }_{0}^{∞} {t}^{2} \cdot {e}^{- \frac{t}{x}} \cdot d t}{{\int }_{0}^{∞} t \cdot {e}^{- \frac{t}{x}} \cdot d t} = \frac{1}{2} \cdot \frac{- {t}^{2} \cdot x \cdot {e}^{- \frac{t}{x}} {\vert}_{0}^{∞} + 2 \cdot x \cdot ( - t \cdot x \cdot {e}^{- \frac{t}{x}} {\vert}_{0}^{∞} + {x}^{2} \cdot {e}^{- \frac{t}{x}} {\vert}_{0}^{∞} )}{- t \cdot x \cdot {e}^{- \frac{t}{x}} {\vert}_{0}^{∞} + {x}^{2} \cdot {e}^{- \frac{t}{x}} {\vert}_{0}^{∞}} = \frac{2 \cdot {x}^{3}}{2 \cdot {x}^{2}} = x \qquad ( 9 )$$

Equation 10 shows if the integration is not infinite, the computed x′ can be written as the decay constant x multiplied by a correction term.

$${x}^{′} = \frac{1}{2} \cdot \frac{{\int }_{0}^{T} {t}^{2} \cdot {e}^{- \frac{t}{x}} \cdot d t}{{\int }_{0}^{T} t \cdot {e}^{- \frac{t}{x}} \cdot d t} = \frac{1}{2} \cdot \frac{- {t}^{2} \cdot x \cdot {e}^{- \frac{t}{x}} {\vert}_{0}^{T} + 2 \cdot x \cdot ( - t \cdot x \cdot {e}^{- \frac{t}{x}} {\vert}_{0}^{T} + {x}^{2} \cdot {e}^{- \frac{t}{x}} {\vert}_{0}^{T} )}{- t \cdot x \cdot {e}^{- \frac{t}{x}} {\vert}_{0}^{T} + {x}^{2} \cdot {e}^{- \frac{t}{x}} {\vert}_{0}^{T}} = x \cdot [ 1 - \frac{1}{2} \cdot \frac{{( \frac{T}{x} )}^{2} {e}^{- \frac{T}{x}}}{1 - {e}^{- \frac{T}{x}} - \frac{T}{x} {e}^{- \frac{T}{x}}} ] \qquad ( 10 )$$

Equation 11 shows the correction term can be approximated by T/x′.

$$Finite\_corr ≡ \frac{{x}^{′}}{x} = [ 1 - \frac{1}{2} \cdot \frac{{( \frac{T}{x} )}^{2} {e}^{- \frac{T}{x}}}{1 - {e}^{- \frac{T}{x}} - \frac{T}{x} {e}^{- \frac{T}{x}}} ] \approx 1 - {e}^{{a}_{1} \cdot {( \frac{T}{{x}^{′}} )}^{3} + {a}_{2} \cdot {( \frac{T}{{x}^{′}} )}^{2} + {a}_{3} \cdot ( \frac{T}{{x}^{′}} ) + {a}_{4}} \qquad ( 11 )$$

Equation 12 shows one can obtain the decay constant x by applying the approximated correction term to x′.

$$x = \frac{{x}^{′}}{Finite\_corr} \approx \frac{{x}^{′}}{1 - {e}^{{a}_{1} \cdot {( \frac{T}{{x}^{′}} )}^{3} + {a}_{2} \cdot {( \frac{T}{{x}^{′}} )}^{2} + {a}_{3} \cdot ( \frac{T}{{x}^{′}} ) + {a}_{4}}} \qquad ( 12 )$$

Equation 13 shows the apparent decay constant T can be computed by applying the same approximated correction term to a measured discrete neutron decay time spectrum. At the end, the apparent sigma can be computed from the apparent decay constant T using Equation 7.

$$τ = \frac{{τ}^{′}}{Finite\_corr} \approx \frac{{τ}^{′}}{1 - {e}^{{a}_{1} \cdot {( \frac{T}{{τ}^{′}} )}^{3} + {a}_{2} \cdot {( \frac{T}{{τ}^{′}} )}^{2} + {a}_{3} \cdot ( \frac{T}{{τ}^{′}} ) + {{a}_{4}}^{ }}} , \\ where T = {t}_{I} - {t}_{0} \qquad ( 13 )$$

By comparing the first and second order moment methods, one can easily extend the above methods to higher order moments by computing, e.g., (n+1)^{th} order moment divided by the n^{th} order moment, or n^{th} order moment divided by an m^{th} order moment and then raise the result of the division to the power of m/n.

Varying the starting time (t₀) and end time (T) of the measurement time gate will change the borehole and diffusion effect in the apparent sigma computed using the second order moment method, similar to the first order moment method. An apparent sigma with an early measurement gate starting time will have more wellbore and diffusion effect than the one with a late starting time, because borehole decay and diffusion typically happen early and formation decay often happens late. The apparent sigma computed by the first and second order moment methods based on the same timing gate will have different borehole and diffusion effects. The moment is essentially a weighted sum with the current time as the weight. A higher order moment will have higher weight for the later time compared to a lower order moment. Since borehole effects and diffusion typically happen earlier than the formation decay, an apparent sigma computed using a higher order moment will have less borehole and diffusion effects than the one computed using a lower order moment method.

The zero order moment method is somewhat different from the higher order moment methods. As shown in Equation 14, the apparent decay constant may be computed by a zero order moment (simply a sum of the decay spectrum) within one timing gate (t₀ to t_{N}) divided by another zero order moment within different timing gate (t₀ to t_{M}).

$${τ}^{′} = \frac{{\sum }_{i = 0}^{N} {f}_{i}}{{\sum }_{i = 0}^{M} {f}_{i}} \qquad ( 14 )$$

Ideally, t_{N} would be infinity and t_{M} equal to t₀ as shown in Equation 15.

$$\frac{{\int }_{0}^{∞} {e}^{- \frac{t}{x}} \cdot d t}{{e}^{- \frac{t}{x}} {\vert}_{t = 0}} = \frac{x \cdot {e}^{- \frac{t}{x}} {\vert}_{0}^{∞}}{1} = x \qquad ( 15 )$$

Essentially, this method computes the decay constant by using the sum of the decay curve divided by the value of the decay curve (i.e., the counting rate) at time 0. As explained above, the decay curve is not measured to infinite time. In addition, one cannot measure the decay curve instantaneously but only as a summation of the number of detected radiation events in a discrete time bin. Equation 16 shows the result of the zero order moment method x′ for a single exponential decay.

$${x}^{′} = \frac{{\int }_{0}^{TN} {e}^{- \frac{t}{x}} \cdot d t}{{\int }_{0}^{TM} {e}^{- \frac{t}{x}} \cdot d t} = \frac{x \cdot {e}^{- \frac{t}{x}} {\vert}_{0}^{TN}}{x \cdot {e}^{- \frac{t}{x}} {\vert}_{0}^{TM}} = \frac{x \cdot ( 1 - {e}^{- \frac{TN}{x}} )}{x \cdot ( 1 - {e}^{- \frac{TM}{x}} )} = \frac{( 1 - {e}^{- \frac{TN}{x}} )}{( 1 - {e}^{- \frac{TM}{x}} )} \qquad ( 16 )$$

If T_{N} goes to infinity and T_{M} goes to 0, x′ will converge to x/TM. Based on Equation 16, one can study the relationship between x′ and x giving a TN and TM, then use x′ to approximate x empirically.

Equation 17 shows one example of approximating x using x′ based on a fifth order polynomial equation obtained by data fit. The coefficients of the polynomial are a function of TM and TN.

x≈a₁·x′⁵+a₂·x′⁴+a₃·x′³+a₄·x′²+a₅·x′+a₆ (17)

Applying the same polynomial equation, one can obtain τ T from τ′ as shown in Equation 18. At the end the apparent sigma can be computed using Equation 7.

τ≈a₁·τ′⁵+a₂·τ′⁴+a₃·τ′³+a₄·τ′²+a₅·τ′+a₆ (18)

Similarly to the two previous methods, varying the timing gate from early to late, the borehole and diffusion effects in the apparent sigma computed using the zero order moment method will become less. The apparent sigma from the zero order moment method has more borehole and diffusion effects than the higher order moment methods due to the relatively smaller weight applied to later in the time gate.

One can also compute the apparent decay constant by applying a single exponential fit within a certain timing gate of the decay time spectrum. This may be a non-linear fit, due to the present of activation gamma rays and nature gamma rays from formation. One can periodically turn off the PNG and measure the background, then remove them from the decay spectrum. The fitting can become a linear fit after taking a log of the background corrected decay spectrum.

Because the measured thermal neutron decay time spectrum is usually not a single decay constant exponential decay, the apparent sigma computed using the methods described earlier will need additional correction to compensate for wellbore and diffusion effects. The finite integral correction terms as shown in Equation 6, Equation 13, and Equation 18 do not correct the computed apparent decay constant to the true formation decay constant, but they are necessary to determine in the present example methods. Without them, compensation techniques described below will not behave linearly so that the correction may be more difficult to perform

Different wellbore and diffusion compensation methods will be described below. All of them may use the difference between the borehole and diffusion effects in two or more apparent values of sigma, which are computed using either different calculation methods or different timing gates, or based on measurements from different detectors, to compensate those effects and obtain an accurate formation sigma without needing a wellbore sigma value as an input. The examples shown are not exhaustive and do not limit the scope of the present disclosure. One can combine two or more different compensation methods or extend them readily. Different example methods which can be applied to single detectors will be described first, and then example methods for multiple detectors will be described.

The examples shown are based on modeling data, which were computed using a Monte Carlo method (MCNP) in an 8 inch wellbore with a 5.5-in. OD casing with 4.95 in. ID. The wellbore can be filled with either fresh water or saline water (250 ppk). 33 different formation conditions were modeled: sandstone, limestone, dolomite with 0-pu, (pu represents “porosity units” or fractional volume of pore space times 100 in a particular formation) 2.5-pu, 5-pu, 10-pu, 20-pu, and 40-pu filled with fresh water in the pore spaces; sandstone 10-pu, 20-pu, and 40-pu with saline water (100 ppk, 200 ppk and 260 ppk) in the pore spaces; and sandstone, limestone, dolomite with 5-pu or 10-pu filled with methane gas (0.15 g/cc).

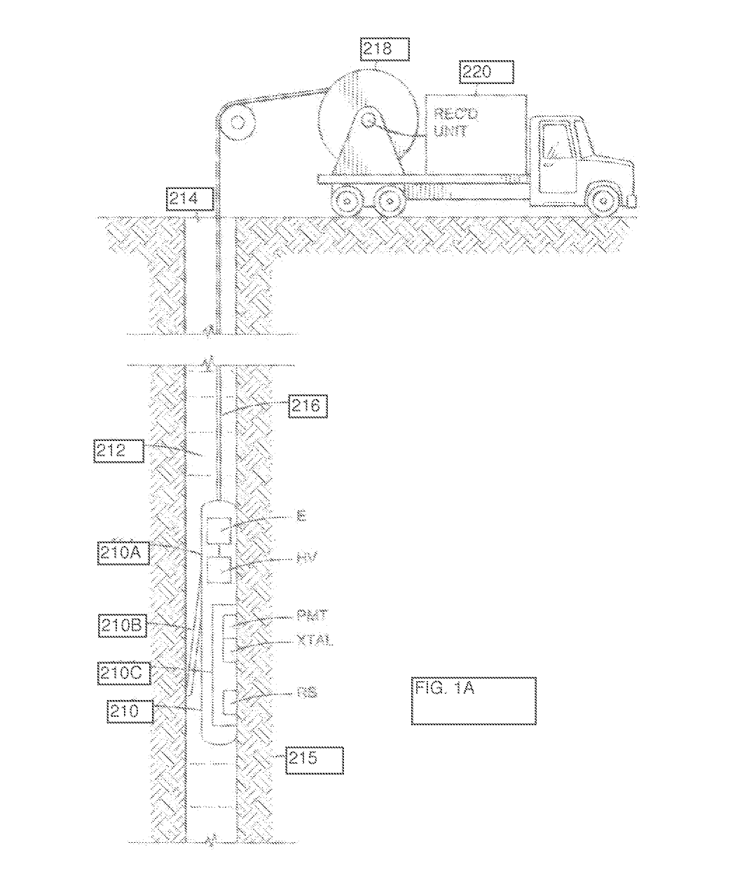

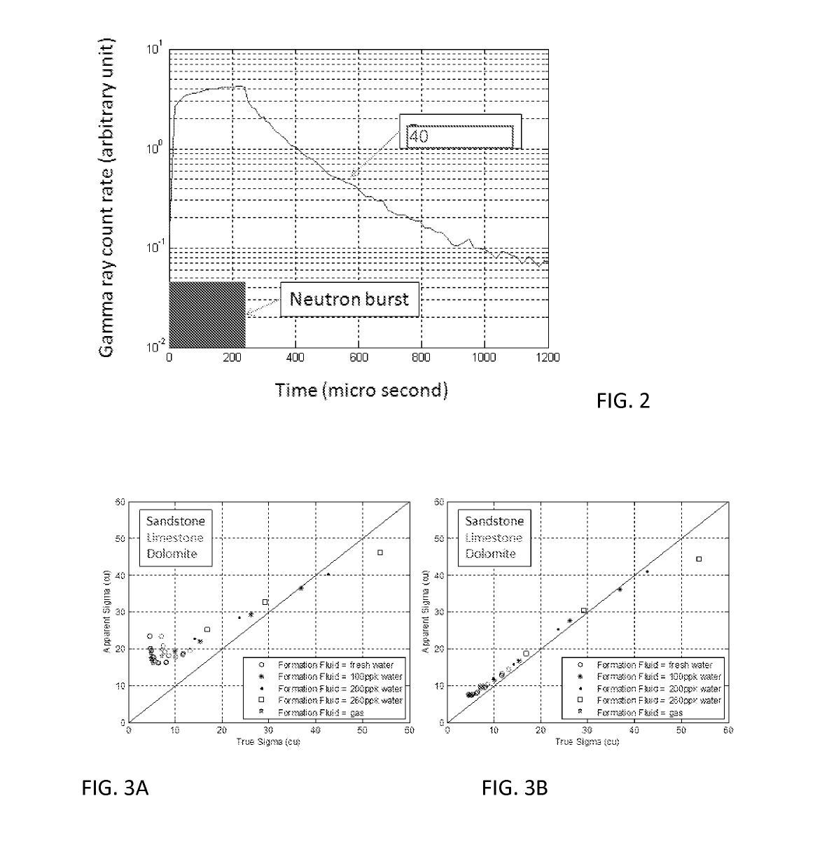

The first example uses the first order moment method to compute two (or more) apparent sigma values based on different timing gates. FIGS. 3A and 3B show the two apparent sigma values as a function of true formation sigma in a fresh water borehole. The apparent sigma in FIG. 3A is based on an early timing gate (from end of the burst to 330 μs after the end of the burst); and the apparent sigma in FIG. 3B is based on a late timing gate (from 330 μs after the end of the burst to 1080 μs as after the end of the burst). The early apparent sigma has more borehole and diffusion effects than the late one, as can be seen in FIG. 3A that it is further away from the 45 degree line. Using any of the moment methods described above, an apparent sigma may be computed for each timing gate.

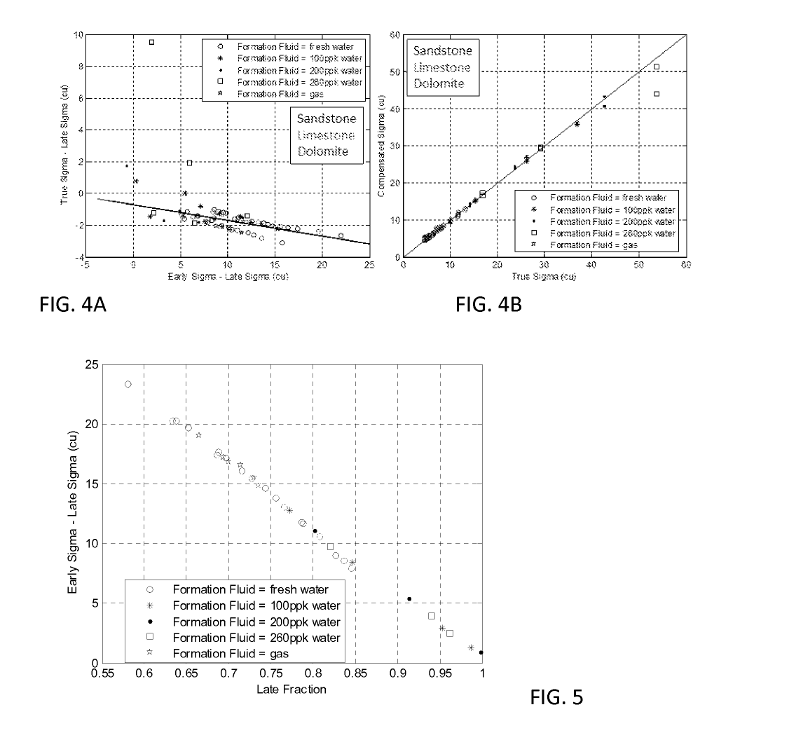

FIG. 4A illustrates how to use the difference between the two apparent sigmas to compensate the borehole and diffusion effects. The x-axis shows the early apparent sigma minus the late one; and the y-axis shows the true formation sigma minus the late apparent sigma. The y-axis is the required compensation term for the late apparent sigma. The required compensation term is not very large, because an apparent sigma based on a very late timing gate has small borehole and diffusion effects. There are two different borehole fluids, one is fresh water and the other is 250 ppk saline water, corresponding to the two bands in FIG. 4A. Overall, one can just use one linear function to fit most of the points within 1 cu (capture unit) error, except under crossover conditions, explained further below, which are the points above 0 (require positive correction). Based on linear fitting, one can estimate the compensation term using Equation 19.

comp_term≡Σₜᵣᵤₑ−Σₗₐₜₑ≈−a₁·(Σ_{early}−Σₗₐₜₑ)+a₂ (19)

The estimated sigma can then be computed as shown in Equation 20.

Σ_{estimated}=Σₗₐₜₑ+comp_term=(1+a₁)·Σₗₐₜₑ−a₁·Σ_{early}+a₂ (20)

Essentially, the estimated sigma is a linear function of the two apparent sigma values plus a constant offset. The sum of the two coefficients for the two apparent sigma is equal to 1 in Equation 20. One can relieve this constraint and fit the three coefficients in Equation 21 based on modeling data (or lab measured data in actual formations using an actual instrument). FIG. 4B shows the estimated sigma, which computed using Equation 21, compared with the true formation sigma, shows the accuracy of this method is very good except for crossover conditions.

Σ_{estimated}=b₁·Σₗₐₜₑ+b₂·Σ_{early}+b₃ (21)

Another compensation method may be obtained by generating the contribution of the late exponential spectrum to the total measured spectrum. The first step in defining this contribution is to determine the apparent decay constant of the late spectrum using the moment method as shown in Equation 22.

$${τ}^{′} = \frac{{\sum }_{i = N}^{I} ( {t}_{i} - {t}_{N} ) \cdot {f}_{i}}{{\sum }_{i = N}^{I} {f}_{i}} \qquad ( 22 )$$

In Equation 22, the sum is over the late bins of the measured spectrum (I is the last bin of the measured spectrum). The apparent decay constant may helpfully be corrected for the finite window used in its computation as shown in Equation 23 (Δ is the bin width [time duration] of the measured spectrum).

$$τ \approx \frac{{τ}^{′}}{1.016 \times ( 1 - 8 \cdot {( \frac{T}{{τ}^{′}} )}^{3} )} , where T = ( I - N + 1 ) \cdot Δ \qquad ( 23 )$$

The starting bin, N, can be optimized. The late spectrum, Li, my be defined for each bin of the measured spectrum as shown in Equation 24.

$${L}_{i} = {e}^{- \frac{( {t}_{i} - {t}_{N} )}{τ}} \cdot \frac{( 1 - {e}^{- \frac{Δ}{τ}} )}{( 1 - {e}^{- \frac{T}{τ}} )} \cdot {\sum }_{j = N}^{I} {f}_{j} \qquad ( 24 )$$

The fraction of counts in the early portion of the measured spectrum that comes from this late contribution may then be defined in Equation 25.

$$late\_fraction = \frac{{\sum }_{i = 0}^{N - 1} {L}_{i}}{{\sum }_{i = 0}^{N - 1} {f}_{i}} = {e}^{\frac{TE}{τ}} \cdot \frac{( 1 - {e}^{- \frac{TE}{τ}} )}{( 1 - {e}^{- \frac{TL}{τ}} )} \cdot \frac{{\sum }_{i = N}^{I} {f}_{i}}{{\sum }_{i = 0}^{N - 1} {f}_{i}} , \\ where TL = ( I - N + 1 ) \cdot Δ and TE = ( N - 1 ) \cdot Δ \qquad ( 25 )$$

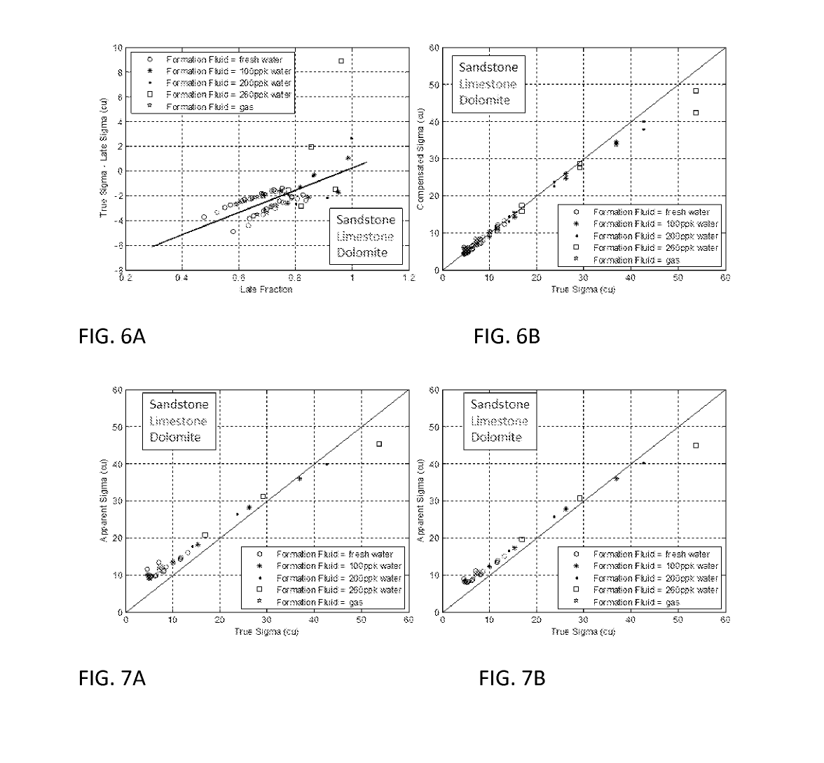

The difference between early sigma and late sigma is close to a linear function of the late fraction, as may be observed in FIG. 5. This means if the required compensation for the late sigma can be estimated based on the difference between early and late sigma, as shown in FIG. 4A, it can also be estimated using the late fraction. This allows true sigma to be determined from the late fraction and the late sigma, as shown in FIG. 6A. The estimated (compensated) sigma can be computed using the late sigma and late fraction term, as shown in Equation 26.

Σ_{estimated}=b₁·Σₗₐₜₑ+b₂·late_fraction+b₃ (26)

FIG. 6B shows the accuracy of the estimation based on Equation 26. The timing gate of this method can be adjusted or optimized for different needs or tool designs. For example, replacing the late sigma in Equation 26 by an early sigma can improve accuracy in some situations.

Comparing the above described correction method to the previous one (early and late first-order moment sigma compensation), one minor difference is that the finite integral correction term is a little different (Equation 23 vs. Equation 6). An important difference is that the above described correction approach uses the late fraction term, which is a complex function of late apparent sigma and a zero order moment (the ratio of the two sum) without finite integral correction. In principle, this approach is the same as the previous one, because FIG. 5 shows this complex term (late fraction) is essentially a linear function of the difference between early and late first-order moment sigma. This example shows a little more complex option to compensate an apparent sigma as an alternative to the previous method.

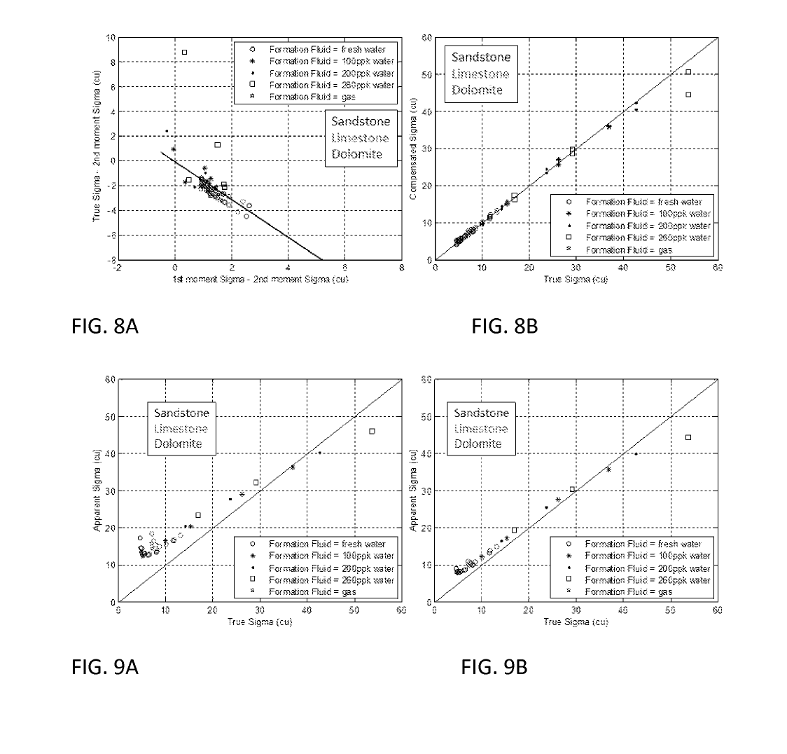

FIGS. 7A, 7B and FIGS. 8A, 8B show another example of how to perform the compensation. Similar to the first example, this time one may use the apparent sigma computed using the first and second order moment methods based on the same timing gate (from 30 μs after the end of the burst to 1080 μs after the end of the burst). FIG. 7A shows the first order moment sigma against the true formation sigma; FIG. 7B shows the second order moment sigma. As can be observed, the first order moment sigma has more borehole and diffusion effects than the second order moment sigma; it is further away from the 45 degree line. This is because the second order moment put more weight on the late time spectrum, which has less borehole and diffusion effects.

FIG. 8A shows the compensation term for the second order moment sigma as a function of the difference between the first and second order moment sigma. Similar to FIG. 4A, one can use a linear function to estimate the compensation term. In this case, the early and late sigma in Equation 19 Equation 20 and Equation 21 may be replaced by the first and second order moment sigma respectively. FIG. 8B shows how accurate the compensation is based on the first and second order moment sigma.

FIGS. 9A, 9B and 10A and 10B show another example of how to perform the compensation. Similar to the first example, this time one may use the zero order moment method to compute early and late apparent sigma based on two different timing gates. FIG. 9A shows the early zero order moment sigma against the true formation sigma; FIG. 9B shows the late zero order moment sigma.

FIG. 10A shows the compensation term for the late zero order moment sigma as a function of the difference between the early and late zero order moment sigma. Similar to FIG. 4A one can use a linear function to estimate the compensation term. In this case, the early and late first order moment sigma in Equation 19 Equation 20 and Equation 21 may be replaced by the early and late zero order moment sigma respectively. FIG. 10B shows how accurate the compensation is based on the first and second order moment sigma.

The different methods to compensate the borehole and diffusion effects described above are based on different apparent sigma. All the foregoing methods can be applied to measurements from only a single detector. If more than one detector is available, depending on the detector spacings from the source, the apparent sigma computed using the same method and same timing gate but different detectors will have different borehole and diffusion effects. Thus, one may take advantage of the apparent sigma from different detectors.

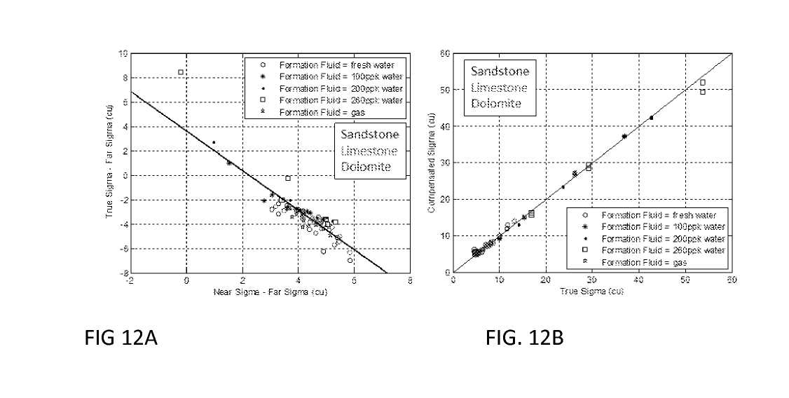

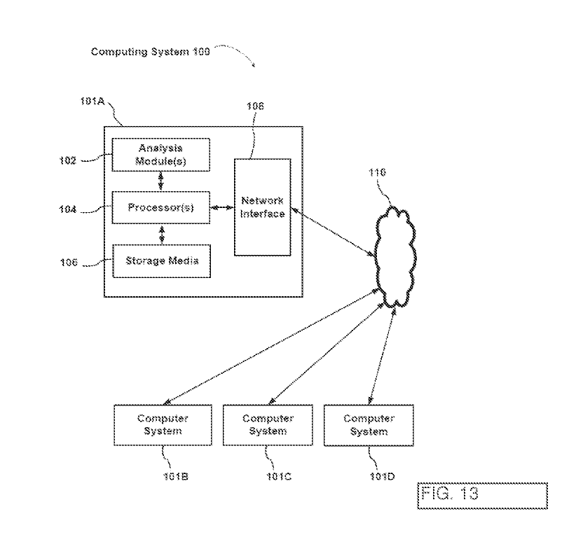

FIGS. 11A, 11B and 12A, 12B show an example for two detectors. Similar to the first example, this time one may use the first order moment method to compute the apparent sigma based on the same timing gate (from 30 μs after the end of the burst to 1080 μs after the end of the burst) for two different detectors. One detector may be about 8.5 inches away from the source and may be called the near detector, and the other which is about 16 inches away from the source may be called the far detector. FIG. 11A shows the near apparent sigma with respect to the true formation sigma; FIG. 11B shows the far apparent sigma. The near apparent sigma has more borehole and diffusion effects than the far apparent sigma. FIG. 12A shows the compensation term for the far apparent sigma as a function of the difference between the near and far sigma. Similar to FIG. 4A one can use a linear function to estimate the compensation term. In this case, the early and late first order moment sigma in Equation 19, Equation 20 and Equation 21 may be replaced by the near and far first order moment sigma respectively. FIG. 12B shows how accurate the compensation is based on the near and far apparent sigma.

Note that the accuracy in crossover conditions of the above described multi-detector method is higher than all the methods discussed for single detector. The crossover condition is defined as when the wellbore decay is slower than the formation decay; thus the formation component goes away at the later time and only the wellbore component may remain later in the time spectrum. This is the opposite of the non-crossover condition, in which the wellbore component dominates early in the time spectrum and decays away more quickly than the formation and leaves more formation component later in the time gate. The methods for a single detector are based on different borehole and diffusion effects in different timing. In crossover conditions, the compensation fails. The multi-detector method is not based on different timing so that it does not have this problem.

Methods according to the present disclosure may provide accurate formation sigma values under a wide range of wellbore and formation conditions, in particular without the need to have a known value of wellbore sigma as an input.

FIG. 13 shows an example computing system 100 in accordance with some embodiments. The computing system 100 may be an individual computer system 101A or an arrangement of distributed computer systems. The computer system 101A may include one or more analysis modules 102 that may be configured to perform various tasks according to some embodiments, such as the tasks described with reference to FIGS. 2A, 2B to 12A, 12B. To perform these various tasks, analysis module 102 may execute independently, or in coordination with, one or more processors 104, which may be connected to one or more storage media 106. The processor(s) 104 may also be connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be on a ship underway on the ocean or on a well drilling location, while in communication with one or more computer systems such as 101C and/or 101D that may be located in one or more data centers on shore, aboard ships, and/or located in varying countries on different continents).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the exemplary embodiment of FIG. 13 the storage media 106 are depicted as within computer system 101A, in some embodiments, the storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above may be provided on one computer-readable or machine-readable storage medium, or alternatively, can be provided on multiple computer-readable or machine-readable storage media distributed in a large system having possibly plural nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the example embodiment of FIG. 13, and/or computing system 100 may have a different configuration or arrangement of the components depicted in FIG. 13. The various components shown in FIG. 13 may be implemented in hardware, software, or a combination of both hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining a thermal neutron decay constant for a rock formation, comprising:
(a) accepting as input to a computer, numbers of radiation events detected by at least a first radiation detector, the events corresponding to numbers of thermal neutrons with respect to time (decay spectrum) after irradiating the rock formation with neutrons;
(b) determining in the computer, at least one moment of a first order of the decay spectrum or a single exponential curve to fit the decay spectrum;
(c) determining in the computer a first apparent decay constant from the at least one moment or the single exponential curve; and
(d) repeating (b) and (c) for at least one of different time segments of the decay spectrum and radiation events detected by at least a second radiation detector at a different spacing from a position of the irradiating than the at least a first radiation detector to determine a second apparent decay constant; and
(e) determining in the computer a wellbore corrected thermal neutron decay constant from the first and second apparent decay constants.

2. The method of claim 1 wherein the first order is one or two.

3. The method of claim 1 wherein a linear combination of the first and second apparent decay constants is used to estimate a correction factor for determining the corrected thermal neutron decay constant.

4. The method of claim 1 wherein the first and second apparent decay spectra are converted into corresponding decay constants using an empirical correction factor.

5. The method of claim 4 wherein the empirical correction factor comprises a polynomial expression in terms of apparent decay time.

6. The method of claim 1 further comprising determining in the computer at least one additional moment of the decay spectrum having a second order, and determining the apparent decay constant by dividing the at least one moment by the at least one additional moment and exponentiating the result thereof to a power of the dividend of the order of the at least one additional moment and the order of the at least one moment.

7. The method of claim 1 wherein the order of the at least one moment is zero, and the apparent decay constant is determined in the computer by dividing the zero order moment of a first selected time segment of the decay spectrum by a zero order moment of a second selected time duration segment of the decay spectrum.

8. The method of claim 1 wherein the at least a first radiation detector comprises at least one of a thermal neutron capture gamma ray detector and a thermal neutron detector.

9. The method of claim 1 further comprising determining in the computer a thermal neutron capture cross section from the wellbore corrected thermal neutron decay constant.

10. A method for determining a thermal neutron decay constant for a rock formation, comprising:
(a) moving a well logging instrument along a wellbore drilled through the rock formation;
(b) irradiating the formation with bursts of neutrons;
(c) detecting radiation events using at least a first radiation detector, the events corresponding to numbers of thermal neutrons with respect to time (decay spectrum) after irradiating the rock formation with neutrons;
(d) determining in a computer, at least one moment of a first order of the decay spectrum or a single exponential curve to fit the decay spectrum;
(e) determining in the computer a first apparent decay constant from the at least one moment or the single exponential curve; and
(f) repeating (d) and (e) for at least one of different time segments of the decay spectrum and radiation events detected by at least a second radiation detector at a different spacing from a position of the irradiating than the at least a first radiation detector to determine a second apparent decay constant; and
(g) determining in the computer a wellbore corrected thermal neutron decay constant from the first and second apparent decay constants.

11. The method of claim 10 wherein the first order is one or two.

12. The method of claim 10 wherein a linear combination of the first and second apparent decay constants is used to estimate a correction factor for determining the corrected thermal neutron decay constant.

13. The method of claim 10 wherein the first and second apparent decay spectra are converted into corresponding decay constants using an empirical correction factor.

14. The method of claim 13 wherein the empirical correction factor comprises a polynomial expression in terms of apparent decay time.

15. The method of claim 10 further comprising determining in the computer at least one additional moment of the decay spectrum having a second order, and determining the apparent decay constant by dividing the at least one moment by the at least one additional moment and exponentiating the result thereof to a power of the dividend of the order of the at least one additional moment and the order of the at least one moment.

16. The method of claim 10 wherein the order of the at least one moment is zero, and the apparent decay constant is determined in the computer by dividing the zero order moment of a first selected time segment of the decay spectrum by a zero order moment of a second selected time duration segment of the decay spectrum.

17. The method of claim 10 wherein the at least a first radiation detector comprises at least one of a thermal neutron capture gamma ray detector and a thermal neutron detector.

18. The method of claim 10 further comprising determining in the computer a thermal neutron capture cross section from the wellbore corrected thermal neutron decay constant.
